(19) United States
(12) Patent Application Publication
(10) Pub. No.: US 2010/0128181 A1
(43) Pub. Date: May 27, 2010

(54) Seam Based Scaling of Video Content

(75) Inventor: Adil JAGMAG, Hollis, NH (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Advanced Micro Devices, Inc., Sunnyvale, CA (US)

(21) Appl. No.: 12/277,853

(22) Filed: Nov. 25, 2008

(51) Int. Cl. H04N 5/262; H04N 5/38; G06K 9/46

(52) U.S. Cl. 348/581; 348/723; 348/E05.055; 382/190; 348/E05.093

(57) ABSTRACT

Methods and systems are provided for processing video data. In an embodiment, a method of scaling video data includes scaling one frame based on at least one seam of pixels of the one frame. The seam of pixels is selected based at least on information derived from at least one of: a previous frame and metadata relating to the one frame. In an embodiment, a method of processing video data includes determining whether a frame is to be scaled based on at least one seam of pixels based on at least one of information derived from the frame or metadata relating to the frame. The at least one seam of pixels is selected based at least on an energy associated with each pixel of the at least one seam of pixels.

### BACKGROUND OF THE INVENTION

1. Field of the Invention

The present invention relates to processing video content. More specifically, the present invention relates to scaling video content.

2. Background Art

Scaling video content received from a broadcaster or any video source (such as, for example, a DVD or electronic file) can be done so that the video content can be displayed at a receiver. For example, received video content can be scaled so that the aspect ratio of the video content matches the aspect ratio of a display device (e.g., television screen, computer monitor, cellular phone display, etc.). In such a manner, a broadcaster can transmit video content in a single aspect ratio and have each receiver scale the video content based on their respective display properties.

Uniform scaling involves uniformly adding or removing pixels from each frame of the video content. Uniform scaling can be combined with pillow or letter boxing (e.g., black bars) to change the aspect ratio of received video content. However, uniform scaling can lead to artifacts in areas that have detail.

Anamorphic scaling relies on the assumption that the subject typically remains in the center of each frame of the video content and that the human eye tends to sharply capture images in the center of its field of vision and blur images toward the outside. Anamorphic scaling results in the center portion of the frames of the video content being scaled the least and increasing the amount of scaling (e.g., the number of pixels added or removed) extending from the center. However, anamorphic scaling can lead to stretching artifacts that can be especially pronounced when attempting to display panning.

Thus, what are needed are methods and systems for scaling video content without degrading its quality, especially in detailed and important areas.

### BRIEF SUMMARY OF THE INVENTION

Embodiments described herein relate to methods and systems for processing video content. In an embodiment, frames of video content can be scaled by selecting seams based on an energy associated with the seam and information available in the video processing environment such as information provided by the broadcaster, temporal information, and/or information derived from the frame itself. Seams are chosen so as to avoid important and detailed portions of the frame so that those areas are not distorted by the scaling process.

In an embodiment, a method of scaling video data includes scaling one frame based on at least one seam of pixels of the one frame. The seam of pixels is selected based at least on information derived from at least one of: a previous frame and metadata relating to the one frame.

In another embodiment, a method of processing video data includes determining whether a frame is to be scaled based on at least one seam of pixels based on at least one of information derived from the frame or metadata relating to the frame. The at least one seam of pixels is selected based at least on an energy associated with each pixel of the at least one seam of pixels.

In an embodiment, a method of communicating video data includes transmitting a frame and metadata associated with the frame to a receiver. The metadata comprises at least one of data used by the receiver to decide whether to scale the frame based on at least one seam of pixels and data used by the receiver to select the at least one seam of pixels.

In still another embodiment, a system for scaling video data includes a processor and a memory in communication with said processor. The memory stores processing instructions for directing the processor to receive one frame of the video data from a transmitter and scale the one frame based on at least one seam of pixels of the one frame. The seam of pixels is selected based at least on information derived from a previous frame of the video data or information received from the transmitter.

In an embodiment, a system for scaling video data includes a processor and a memory in communication with said processor, said memory for storing a plurality of processing instructions for directing said processor to scale one frame based on at least one seam of pixels of the one frame. The seam of pixels is selected based at least on information derived from at least one of a previous frame and metadata relating to the one frame.

In another embodiment, a system for communicating video data includes a processor and a memory in communication with said processor, said memory for storing a plurality of processing instructions for directing said processor to transmitting a frame and metadata associated with the frame to a receiver, wherein the metadata comprises at least one of data used by the receiver to decide whether to scale the frame based on at least one seam of pixels and data used by the receiver to select the at least one seam of pixels.

In an embodiment, a computer readable medium carrying one or more sequences of one or more instructions for execution by one or more processors to perform a method of scaling video data, the instructions when executed by the one or more processors, cause the one or more processors to scale one frame based on at least one seam of pixels of the one frame. The seam of pixels is selected based at least on information derived from at least one of: a previous frame and metadata relating to the one frame.

Further features and advantages of the invention, as well as the structure and operation of various embodiments of the invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram illustration of a system for providing video content for display, according to an embodiment of the present invention.

FIG. 2 shows an image including low energy seams.

FIG. 3 shows a plot of an energy function corresponding to the image of FIG. 2.

FIGS. 4 and 5 show scaled images.

FIG. 6 is a flowchart of an exemplary method of scaling video content, according to an embodiment of the present invention.

FIG. 7 shows example steps that may be performed during the flowchart of FIG. 6, according to embodiments of the present invention.

FIG. 8 is a flowchart of an exemplary method of generating video content, according to an embodiment of the present invention.

The present invention will be described with reference to the accompanying drawings. Generally, the drawing in which an element first appears is typically indicated by the leftmost digit(s) in the corresponding reference number.

### DETAILED DESCRIPTION OF THE INVENTION

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

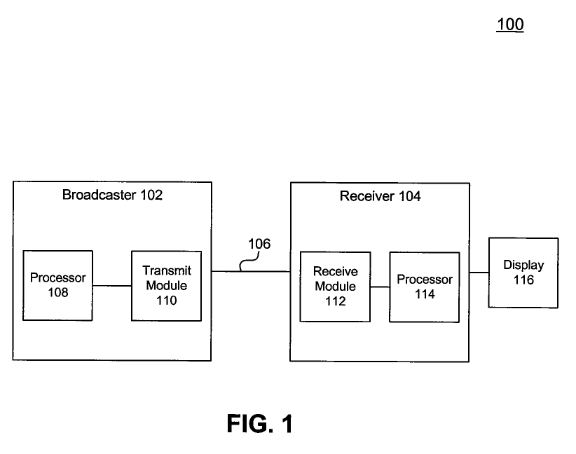

FIG. 1 shows block diagram illustration of a system 100 for providing video content for display. System 100 includes a broadcaster 102, a link or transmission medium 106, a receiver 104, and a display device 116. Broadcaster 102 includes a processor 108 and a transmit module 110. Video content or video data, used interchangeably herein, broadcasted by broadcaster 102 includes a set of frames. In an embodiment, each frame is similar to a still image. When the frames are displayed sequentially with a desired frequency by display device 106, a user viewing display device 106 perceives objects pictured by the frames as moving continuously. The video content can also include metadata corresponding to one or more of the frames that can be used to process the frames.

Processor 108 executes instructions to perform a variety of tasks. For example, processor 108 can generate frames of video data. Processor 108 can also generate metadata that is to accompany the generated frames of video data. Processor 108 sends the generated frames and the metadata to transmit module 110. Transmit module 110 performs operations so that the video content can be transmitted efficiently over transmission medium 106. For example, transmit module 110 can modulate the video content so that it can be transmitted over transmission medium 106.

Transmission medium 106 can include many different transmission mediums known to those skilled in the art. For example, transmission medium 106 can include coaxial cable, fiber optic cable, or a twisted pair line. In another embodiment, broadcaster 102 can broadcast the video data wirelessly to receiver 104, in which case transmission medium 106 would be the medium through which the electromagnetic waves travel (e.g., air). Furthermore, transmission medium 106 may also represent a combination of transmission mediums, e.g., air and coaxial cable. Additionally, as will be appreciated by those of ordinary skill in the art, broadcaster 102 need only be a source of video content or video data and may include, for example, a DVD, an online video content source or site and the like.

Receiver 104 includes a receive module 112 and a processor 114. In an embodiment, receive module 112 effectively reverses the operations executed by transmit module 110 of broadcaster 102. For example, receive module 112 can perform demodulation operations corresponding to modulation operations of transmit module 110. Receive module 112 can also condition a received signal so that it is more likely to be interpreted correctly, e.g., in the presence of noise in transmission medium 106. For example, receive module 112 may include one or more filters that filters out unwanted noise. Video content that is recovered by receive module 112 is received by processor 114. Processor 114 processes the received video content and the accompanying metadata so that the video content can be displayed on display device 116.

Display device 116 displays video content received from receiver 104. For example, display device 116 can be a television. Alternatively, display device 116 can be a computer monitor (e.g., when receiver 104 is a computer) or a wireless device screen (e.g., when receiver 104 is a wireless device such as a cellular phone).

Processor 114 scales received frames of the video content so that they can be displayed on display device 116. Scaling relates to the adding pixels to or removing of pixels from a frame. Thus, scaling can effectively amount to replicating data, e.g., scaling up, or removing data, e.g., scaling down. Alternatively, scaling can include interpolating between pixels to determine a value for an added pixel to scale up or blending the information of a first set of pixels into a second set of pixels having fewer pixels than the first set to scale down. In an embodiment, processor 114 scales received frames of video content to change the aspect ratio of the received frames, e.g., from 4/3 to 16/9. Processor 114 can use conventional techniques to scale the received frames. For example, processor 114 can uniformly scale the received frames. In such an embodiment, processor 114 uniformly adds or removes pixels from received frames. Uniform scaling may be used to preserve the aspect ratio of the received frames of video data and pillow or letter boxing techniques, e.g., black bars, can be used to fill in any gaps in display device 116. However, uniform scaling can lead to artifacts in the frames in areas of the frames that have detail.

In an alternate embodiment, processor 114 can scale received frames anamorphically. In anamorphic scaling, the center of a frame is scaled the least and the frame is scaled more towards the edges of the frame. Since the subject is typically in the center of the frame and the human eye tends to blur images outside the center of its field of vision, anamorphic scaling can limit distortion to detailed objects as long as they remain close to the center of a frame. However, anamorphic scaling can also lead to stretching artifacts especially when panning.

In another embodiment, processor 114 can crop the frames of the video content to scale down. In cropping frames of the video content, processor 114 removes edge portions of the frames. However, cropping can result in important or detailed objects located near the edge portions of the frames being removed, and thus creating the loss of important information.

In an embodiment, processor 114 can perform other operations on the received video content. For example, processor 114 can perform deinterleaving and/or anti-aliasing operations. In another embodiment, receive module 112 can perform deinterleaving and/or anti-aliasing operations.

As would be apparent to those skilled in the art, system 100 can include additional components not shown in FIG. 1. For example, system 100 may additionally include one or more amplifiers that amplify the signal broadcast by broadcaster 102 so that it can reliably reach receiver 104.

### Content-Aware Scaling of Images

Content-aware scaling can be used to ensure pixels located in detailed regions of a frame are not used in scaling so as to prevent artifacts and distortions from degrading the quality of detailed aspects of the frame. Specifically, content-aware scaling can use energy associated with pixels to decide which pixels should be used to scale the image. A content-aware scaling operation can include removing a low energy seam of pixels or adding pixels in the proximity to a low energy seam of pixels.

As described herein, a seam is a connected path of pixels. In a further embodiment, the seam connects one side of an image to another. For example, a seam can connect opposite sides of an image together. In such an embodiment, a seam can be classified as being either vertical or horizontal based on the sides of the image that it connects.

A scaling up operation can include adding pixels along a low energy seam, e.g., adding pixels with values equal to the average of a pixel of the seams and one or more of its neighbors. A scaling down operation can include the removing of pixels of a low energy seam. A low energy seam can be a seam of pixels that has a low total energy compared to other seams, a seam that has a low median energy, a seam that has a low average energy, or is otherwise defined as having low energy according to one or more statistical operators known to those skilled in the art.

The energy function of an image can be calculated in a variety of ways. For example, as described in Seam Carving for Content-Aware Image Resizing, by Shai Avidan and Ariel Shamir, which is incorporated by reference herein in its entirety, the energy function can be defined as:

$${e}_{1} ( I ) = \vert \frac{\partial }{\partial x} I \vert + \vert \frac{\partial }{\partial y} I \vert ,$$

where I represents the image.

Other methods of calculating the energy function of an image can also be used. For example, a segmentation method can be used. In the segmentation method, the image is first segmented, as described in Synergism in Low-Level Vision by Christoudias et al., which is incorporated by reference herein in its entirety, and the e₁ error norm is applied to the results. The energy of a pixel, then, is the value of the energy function evaluated at that pixel.

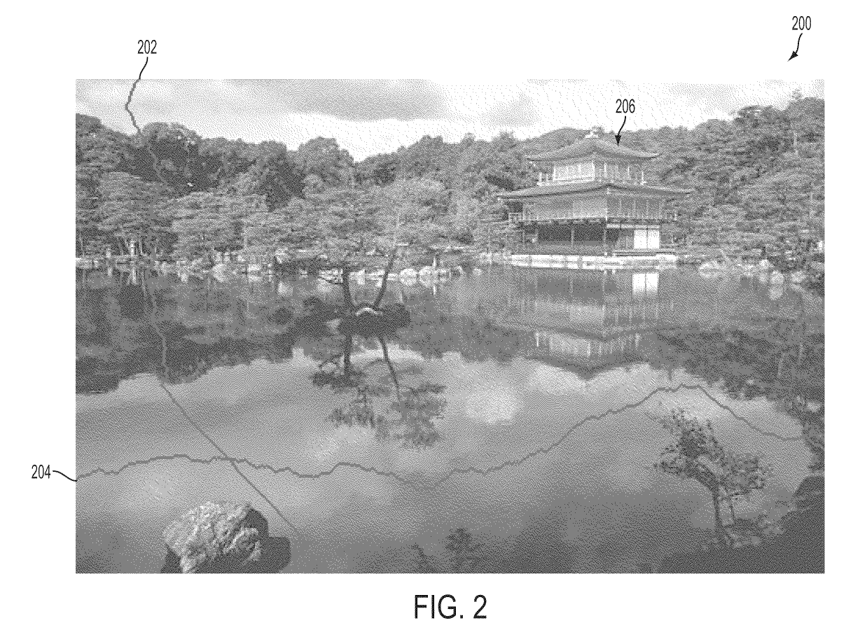

FIG. 2 shows an image 200 that includes low energy seams 202 and 204. As shown in FIG. 2, seam 202 connects the top and bottom edges of image 200 and seam 204 connects the left and right edges of the image. Thus, seams 202 and 204 are vertical and horizontal seams, respectively.

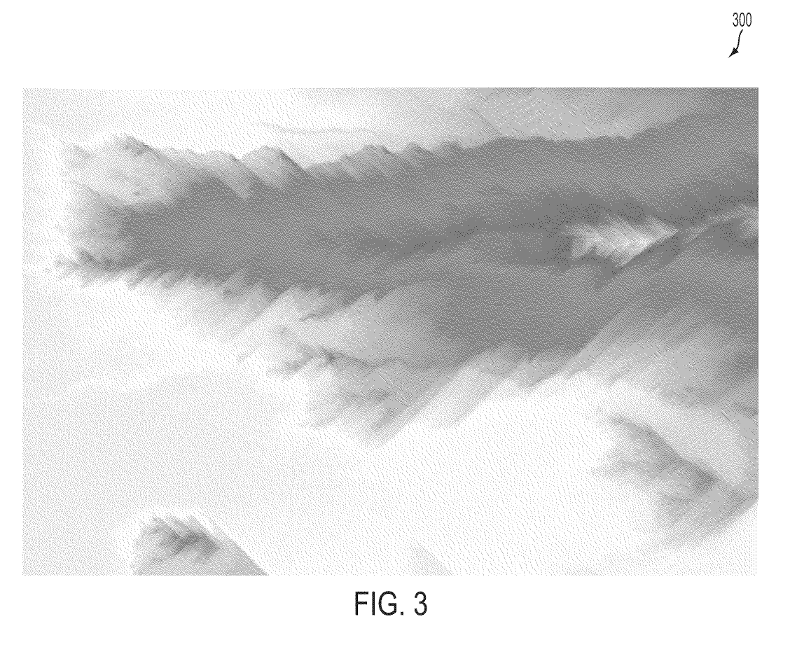

FIG. 3 shows a plot 300 of an energy function corresponding to image 200. Darker regions of plot 300 indicate higher energy regions. By comparing image 200 and plot 300, one skilled in the art will recognize that seams 202 and 204 include pixels of low energy.

Seams 202 and 204 can be used to scale image 200. For example, the pixels in seam 202 can be removed from image 200 to scale down image 200. To scale up image 200, pixels of seam 202 can be averaged with one or more neighbors, e.g., top, bottom, left, or right, to generate new pixels along seam 202. Since seams 202 and 204 have low energy, and thus low detail, scaling image 200 based on seams 202 and 204 will not lead to a significant distortion of the detailed aspects of image 200. For example, a structure 206 will not be distorted by scaling image 200 using seams 202 and/or 204.

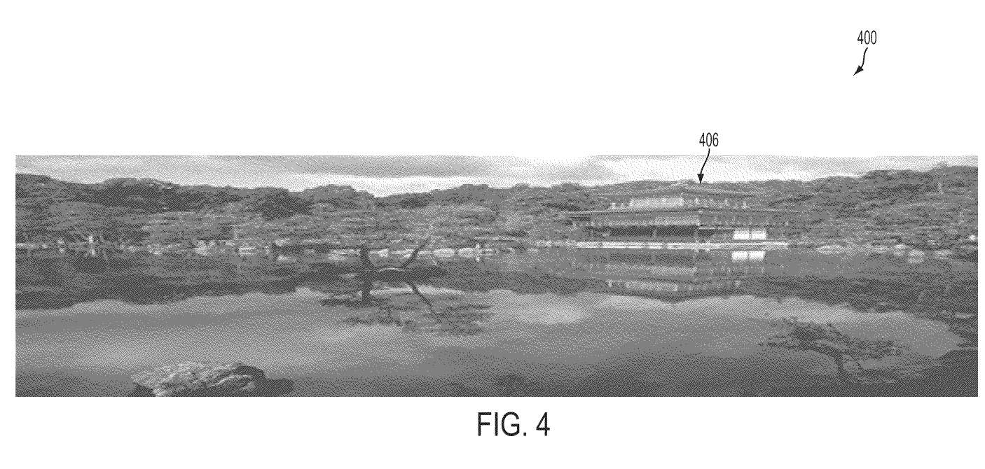

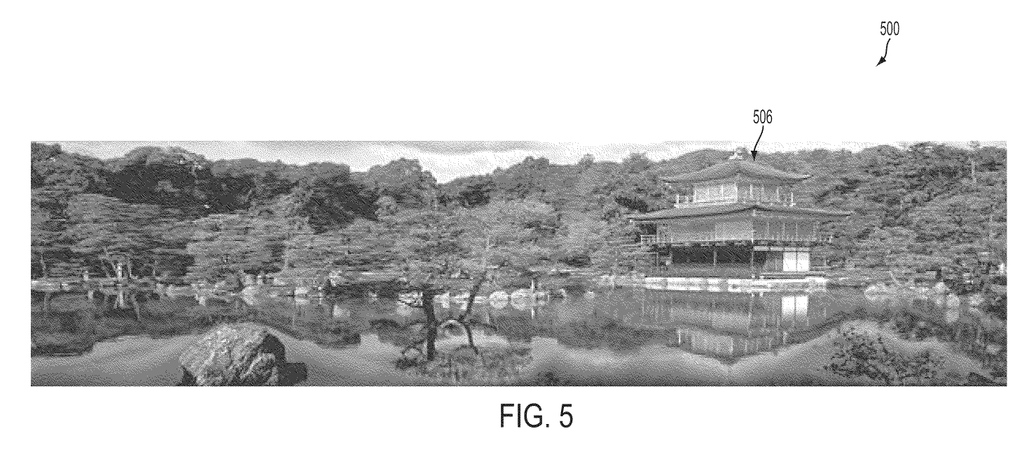

FIG. 4 shows an image 400 that was obtained using uniform scaling of image 200. As shown in FIG. 4, structure 402, corresponding to structure 202 shown in FIG. 2, is significantly distorted in image 400. FIG. 5 shows an image 500 obtained using content-aware scaling of image 200. For example, image 500 may be obtained by scaling image 200 along seams 202, 204 and other low energy seams. As shown in FIG. 5, a structure 502, corresponding to structure 206 in FIG. 2, is not distorted in image 500. Thus, as shown in the embodiments of FIGS. 4 and 5, scaling an image based on low energy seams can prevent the distortion of detailed aspects of the image.

### EXEMPLARY EMBODIMENTS

In embodiments described herein, content-aware seam carving is applied to video data. Information available in a video data environment can be used in addition to energies assigned to the pixels of a frame to select seams based on which a frame will be scaled. For example, the additional information may include temporal data, e.g., information obtained from other frames, and/or information provided by the broadcaster. In another embodiment, it can be decided which of content-aware seam carving and conventional techniques should be used to scale received video data.

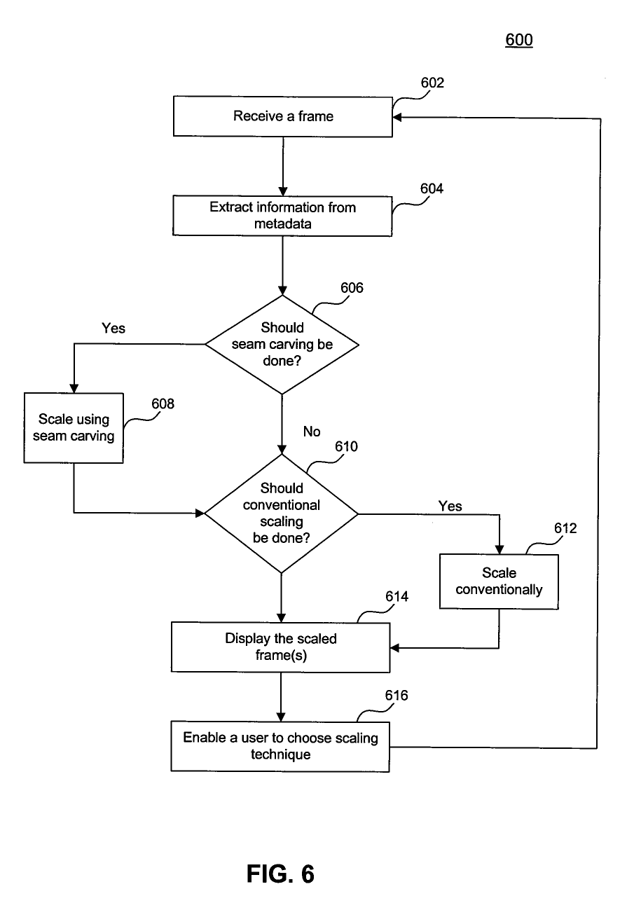

FIG. 6 is a flowchart of an exemplary method 600 of scaling video content, according to the present invention. Other structural and operational embodiments will be apparent to persons skilled in the relevant art(s) based on the following discussion. Flowchart 600 is described with reference to the embodiment of FIG. 1. However, flowchart 600 is not limited to that embodiment. The steps shown in FIG. 6 do not necessarily have to occur in the order shown. The steps of FIG. 6 are described in detail below.

Flowchart 600 begins with step 602. In step 602, a frame of the video content is received from a broadcaster. For example, in FIG. 1, receiver 104 can receive a frame of video content from broadcaster 102 over transmission medium 106. The received frame can be in a variety of different formats. For example, the received frame may be an MPEG, a Divx, or other type of frame that is known to those skilled in the relevant arts.

In step 604, information is extracted from metadata that accompanies the received frame. For example, in FIG. 1, processor 114 can extract information from metadata that accompanies the received frame. Types of information that can be extracted from the metadata will be described further below. As would be apparent to those skilled in the relevant arts, step 604 can be executed as needed throughout the operation of flowchart 600. In other words, information can be extracted from the metadata as required.

In step 606, it is determined whether content-aware seam carving is to be used to scale the received frame. For example, in FIG. 1, processor 114 can determine whether seam carving should be used to scale the received frame. In an embodiment, broadcaster 102 can include instructions in the metadata associated with the received frame. Based on these instructions, processor 114 can determine whether the received frame should be scaled using seam carving.

In an alternate embodiment, processor 114 can determine whether to use seam carving to scale the received frame based on characteristics of the received frame itself. For example, processor 114 can compare the total energy of the received frame, e.g., the sum of all the individual pixel energies, to a threshold. If the total energy is too high, it may be difficult to find a sufficiently low energy seam. Thus, the received frame may not be a good candidate for seam carving and a conventional scaling technique may provide superior quality. The total energy may be calculated by processor 114 by determining the value of the energy function at each pixel of the frame and summing those determined values. Alternatively, the total energy and/or the value of the energy function at each pixel of the frame can be calculated by broadcaster 102 and included in metadata.

Furthermore, a type of programming associated with the received frame can be used to determine whether the seam carving should be used to scale the received frame. For example, certain types of programming may be known to have their detailed areas located in a confined region of the frame, e.g., news programming, and may be a good candidate for seam carving.

In another embodiment, processor 114 can use temporal data to determine whether the received frame should be scaled using seam carving. For example, processor 114 can use information associated with one or more previous frames of video content to determine whether the current frame should be scaled using seam carving. For example, post processing information such as, but not limited to, flesh-tone correction can be used to determine if the detail of a frame is confined in a well defined area. If the detail of a previous frame is confined in a well defined area and it is known that the video content does not substantially change between the previous frame and the current frame, it may be determined that the detail of the current frame is confined to a well defined area and seam carving may be appropriate. Additionally, a decision regarding a scaling technique in a previous frame can be used to determine whether the current frame should be scaled using seam carving. For example, if a previous frame was scaled using seam carving, it is more likely that processor 114 will determine that the current frame should also be scaled using seam carving.

In another embodiment, motion vector information can be used by processor 114 to determine if macro blocks have shifted dramatically. If processor 114 determines that there is significant movement between the macro blocks of the current frame and one or more previous frames, processor 114 can determine that the current frame is not a good candidate for seam carving.

In an embodiment, information from previous frames is only used in a determination regarding the current frame if the previous frames and the current frame are in the same scene. Thus, information stored from previous frames can be reset at scene transitions.

In an embodiment, information obtained from the received frame and/or the previous frames (e.g., motion derived from motion vector information, total energy, etc.) can be compared to one or more thresholds to determine whether the current frame should be scaled using seam carving. The thresholds can be set by processor 114, e.g., determined at manufacturing. In another embodiment, the thresholds can be determined by a user using receiver 104. For example, a manufacturer can set the range of possible threshold values and a user using receiver 104 can choose a value within the set range.

As would be appreciated by those skilled in the art, multiple comparisons regarding one or more types of information described above can be complied to determine whether the current frame should be scaled using seam carving. For example, a number of thresholds that are exceeded can be aggregated. The aggregate value can then be compared to another threshold to make the final determination as to whether the received frame is to be scaled using seam carving.

Criteria used by receiver 104 and processor 114 to determine whether the received frame should be scaled using seam carving can also be used by broadcaster 102 in determining whether a frame should be scaled using seam carving. Thus, broadcaster 102 can use one or more of the criteria described above to determine whether a frame is to be scaled using seam carving and include instructions in metadata associated with the frame that instruct receiver 104 to scale the frame using seam carving.

If it is determined that the received frame should be scaled using seam carving, step 608 is reached. In step 608, the received frame is scaled using seam carving. For example, in FIG. 1, processor 114 can scale the received frame based on seam carving.

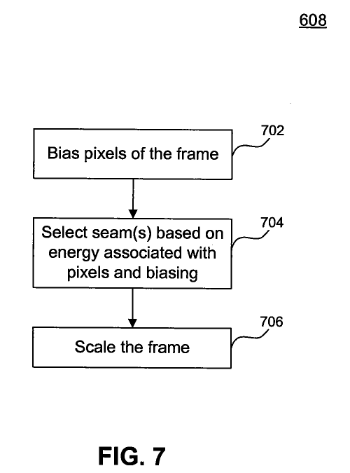

FIG. 7 provides example steps 702-706 for executing step 608, according to an embodiment of the present invention. Steps 702-706 do not have to occur in the order shown.

In step 702, pixels of the received frame are biased. For example, in FIG. 1, processor 114 can bias pixels of the frame so that they are more or less likely to be included in seams that are selected for seam carving. In an embodiment, pixels of the received frame can be biased based on information provided by broadcaster 102, information derived from temporal data, or a combination thereof.

Information provided by broadcaster 102 that can be used to bias pixels of the received frame can be included in metadata associated with the received frame. For example, the metadata may include one or more seams based on which the received frame is be scaled. In such an embodiment, pixels included in the seams provided by the broadcaster can effectively be biased so that they will be selected, e.g., probability of a selection is 1. In an embodiment in which broadcaster 102 provides all the seams based on which the received frame is to be scaled, step 704 can be skipped and step 706 is reached. In another embodiment, broadcaster 102 only provides some of the seams that are to be used in scaling the received frame. In addition to using the provided seams for scaling the received frame, they can also be used to bias pixels in the immediate vicinity of the provided seams so they are more likely to be included in the selected areas.

Information provided by broadcaster 102 can also include a type of programming associated with the received frame. Based on the type of programming, processor 114 can bias certain pixels. For example, for news programming, pixels toward the edge of the frame can be biased higher and pixels toward the center of the frame can be biased lower since the most important information in news programming is typically located in the center of the frame.

Pixels of the received frame can also be biased based on temporal data. For example, pixels of the current frame can be biased based on information obtained from previous frame(s). For example, a seam selected to be used in seam carving in previous frame(s) can be weighted so that it is more likely to be chosen in the current frame so that continuity is maintained between the previous frame(s) and the current frame. Such continuity may be especially important when the previous frame(s) and the current frame are part of the same scene.

Furthermore, motion vector information can also be used to bias pixels of the received frame. For example, motion vector information can be used to identify macro blocks that have moved since a previous frame. Pixels within a macro block that is known to have moved significantly since a previous frame may be weighted lower so that they are less likely to be selected for seam carving. Scaling images based on pixels that are involved in significant movement may lead to degraded quality. The motion vector information can be calculated by receiver 104 or provided by broadcaster 102 in metadata.

Motion vector information can also be used in tandem with seams that were chosen in a previous frame. In such a manner, it can be determined where seams that were chosen in a previous frame have moved to in the current frame.

Information derived from a previous frame can also include post-processing information. For example, flesh-tone correction can be used to indicate areas of the frame that include faces. Since faces are typically an important portion of the frame, such areas can be weighted lower.

Information provided by broadcaster 102 and information derived from previous frame(s) can be used to indicate an importance of a portion of the received frame. Important portions of the current frame are weighted lower so that seams used to scale the received frame are less likely to include pixels from these important areas. For example, seams chosen by the broadcaster, a type of programming, motion vector information, and post-processing information can be used to assign importance to areas of the received frame. Thus, information regarding the importance of an area of the frame is combined with information regarding the detail included in different areas of the frame, e.g., the value of the energy function determined at each of the pixels of the received frame, so that unimportant and uniform (i.e., not detailed) areas of the frame can be chosen for scaling. As would be apparent to those skilled in the relevant arts, processor 114 can also use a combination of information provided by broadcaster 102 and temporal data to bias pixels of the received frame.

Each biasing factor can be used to determine a biasing coefficient for each pixel of the received frame. Biasing coefficients can be determined experimentally and stored in a lookup table. For example, if a pixel was included in a seam selected in a previous frame, an appropriate biasing coefficient can be retrieved from the lookup table. Various biasing coefficients for a pixel can be combined, e.g., through a product or weighted product, to determine a biasing coefficient for each pixel of the received frame.

In step 704, one or more seams of pixels are selected from the received frame for seam carving based at least on energy associated with the pixels and the biasing of step 702. For example, in FIG. 1, processor 114 can select seams of pixels for seam carving. In an embodiment, the selection of one or more seams of pixels for seam carving can be substantially similar to the selection of seam carving in still images as described above. However, instead of looking solely at the energy function for the received frame, biasing coefficients based on step 702 can also be incorporated. Thus, the effective energy of a pixel can be defined as the product of value of the energy function at the pixel and the biasing coefficient determined in step 702. The effective energy can be used instead of the actual energy of the pixel to select the seams. The actual energy associated with each pixel of the frame can be provided by broadcaster 102 and included in metadata or calculated by processor 114.

In step 706, the frame is scaled based on the seams selected in step 704. For example, in FIG. 1, processor 114 can scale the received frame based on one or more selected seams. In an embodiment, scaling of the frame may include removing pixels of the seam, e.g., scaling down. Alternatively, scaling may involve averaging pixels of a seam with its neighbor, e.g., top, bottom, left or right, and inserting a pixel with the average value into the frame, e.g., scaling up. Other scaling operations (e.g., change of aspect ratio) may be a combination of scaling up and scaling down.

Returning to flowchart 600, in step 610, it is determined whether a conventional scaling technique should be used to scale the received frame. For example, in FIG. 1, processor 114 can determine whether a conventional scaling technique should be used to scale the received frame. In an embodiment, the outcome of step 610 is based on the outcome of step 606. For example, if it is determined in step 606 that the seam carving should not be used to scale the received frame, in step 610 it can be determined that the conventional technique should be used to scale the received frame and vice versa.

In an alternate embodiment, processor 114 can consult user preferences stored in receiver 104. Based on these user preferences, processor 114 can determine that both seam carving and conventional scaling should be applied to the received frame. The embodiment in which the received frame is scaled both using seam carving and conventional techniques will be described in further detail below.

In another embodiment, step 610 may involve an inspection of the results of the comparisons of step 606. As described above, step 606 may include the comparison of determined or provided values with respective thresholds. If the results of the comparisons clearly indicate that content-aware seam carving or conventional scaling should be used, only one of steps 606 and 610 have an affirmative result. Alternatively, if the results are mixed, e.g., if some comparisons point to seam carving while others point to conventional scaling, both steps 606 and 610 can have an affirmative result and the received frame is scaled using both seam carving and a conventional scaling technique.

If it is determined in step 610 that a conventional scaling technique is to be used, step 612 is reached. In step 612, the received frame is scaled conventionally. For example, in FIG. 1, processor 114 can scale the received frame using a uniform or anamorphic technique, as described above. As would be apparent to those skilled in the relevant arts based on the description herein, the received frame can be scaled using other conventional techniques without departing from the scope and spirit of the embodiments described herein.

In step 614, the scaled frames are displayed. For example, in FIG. 1, display device 116 displays the scaled frames. In an embodiment, only one of steps 606 and 610 has an affirmative result. In other words, the received frame is either scaled conventionally or using seam carving. In such an embodiment, in step 614 the scaled frame is displayed. In an alternate embodiment, the received frame is scaled both using seam carving and conventional techniques. In such an embodiment, both of the scaled frames are displayed (e.g., side-by-side).

In optional step 616, the user is enabled to choose between seam carving and conventional techniques. For example, in FIG. 1, receiver 104 can enable a user to choose between the seam carving and conventional techniques through suitable interaction with receiver 104 or display device 116. For example, processor 114 may interact with the display device 116 so that both the received frame scaled using seam carving and the received frame scaled using a conventional technique is displayed at once. The user can then decide which technique delivers superior picture quality. The user's choice can be used to determine the outcome of steps 606 and 610 when the next received frame is scaled.

In alternate embodiments, one or more steps of flowchart 600 may be omitted. For example, receiver 104 may be configured such that only seam carving is used to scale received frames. In such an embodiment, only steps 602, 604 and 608 of flowchart 600 would be executed. In another embodiment, receiver 104 may not be configured to enable a user to choose a scaling technique. In such an embodiment step 616 is skipped and flowchart 600 returns to step 602 after completing step 614.

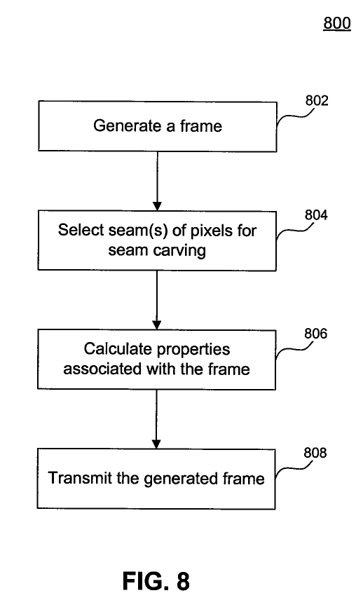

FIG. 8 is a flowchart of an exemplary method 800 of generating video content, according to an embodiment of the present invention. Other structural and operational embodiments will be apparent to persons skilled in the relevant art(s) based on the following discussion. Flowchart 800 is described with reference to the embodiment of FIG. 1. However, flowchart 800 is not limited to that embodiment. The steps shown in FIG. 8 do not necessarily have to occur in the order shown. The steps of FIG. 8 are described in detail below.

In step 802, a frame of video content is generated. For example, in FIG. 1, the processor 108 can generate a frame of video content. The generated frame can be a variety of different types, as described above. For example, the generated frame may be in MPEG or Divx format.

In step 804, seam(s) to be used for seam carving at the receiver are selected. For example, in FIG. 1, processor 108 can select one or more seams to be used by receiver 104 to perform scaling. The selected seams may be selected based on energy associated with pixels in addition to temporal data and information derived from the frame itself, as described above. The selected seams can be included in metadata associated with the generated frame.

In step 806, properties associated with a generated frame are calculated. For example, in FIG. 1, processor 108 can calculate properties associated with a generated frame. The properties calculated by processor 108 can be used by receiver 104 as it processes the generated frame. For example, processor 108 can calculate a total energy associated with the frame. The total energy, as described above, can be used by receiver 104 to decide whether seam carving should be used to scale the received frame. Processor 108 can also calculate individual pixel energies, e.g. the values of the energy function at individual pixels, that can be used by receiver 104 to select seams for seam carving. Furthermore, processor 108 can calculate motion vector information between the generated frame and other frames. Information calculated by processor 108 can be included in metadata that accompanies the generated frame. As would be apparent to those skilled in the relevant arts based on the description herein, processor 108 can also calculate other properties associated with a frame that can be used by receiver 104 to process the generated frame.

In steps 804 and 806 broadcaster 102 performs processing steps that reduce the processing load on receiver 104. In such a manner, broadcaster 102 can reduce the memory and processor requirements for receiver 104. Furthermore, performing calculations on the broadcaster side can decrease the lag time and improve quality for the user viewing the video content on display device 116. Thus, it can be in the interest of broadcaster 102 to perform steps 804 and/or 806 so that the viewing experience of the user is improved.

In step 808, the generated frame and the associated metadata is transmitted to the receiver. For example, in FIG. 1, transmit module 110 can perform modulation in other types of operations so that the generated frame and associated metadata can be transmitted to receiver 104 over transmission medium 106.

The present invention may be embodied in hardware, software, firmware, or any combination thereof. Embodiments of the present invention or portions thereof may be encoded in many programming languages such as hardware description languages (HDL), assembly language, and C language. For example, an HDL, e.g., Verilog, can be used to synthesize, simulate, and manufacture a device, e.g., a processor, application specific integrated circuit (ASIC), and/or other hardware element, that implements the aspects of one or more embodiments of the present invention. Verilog code can be used to model, design, verify, and/or implement a processor that can scale frames using content-aware seam carving. For example, Verilog can be used to generate a register transfer level (RTL) description of logic that can be used to execute instructions so that a frame can be scaled using content-aware seam carving. The RTL description of the logic can then be used to generate data, e.g., graphic design system (GDS) or GDS II data, used to manufacture the desired logic or device. The Verilog code, the RTL description, and/or the GDS II data can be stored on a computer readable medium. The instructions executed by the logic to perform aspects of the present invention can be coded in a variety of programming languages, such as C and C++, and compiled into object code that can be executed by the logic or other device.

Aspects of the present invention can be stored, in whole or in part, on a computer readable media. The instructions stored on the computer readable media can adapt a processor to perform the invention, in whole or in part, or be adapted to generate a device, e.g., processor, ASIC, other hardware, that is specifically adapted to perform the invention in whole or in part

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of scaling video data, comprising:
scaling one frame based on at least one seam of pixels of the one frame;
wherein the seam of pixels is selected based at least on information derived from at least one of: a previous frame and metadata relating to the one frame.

2. The method of claim 1, further comprising:
selecting the at least one seam of pixels based on the information derived from the previous frame and an energy associated with each pixel of the at least one seam of pixels;
wherein the information derived from the previous frame includes post-processing information, a seam chosen in the previous frame, or a motion vector between the one frame and the previous frame.

3. The method of claim 1, wherein the metadata includes a seam of the at least one seam, further comprising:
extracting the seam from the metadata.

4. The method of claim 1, further comprising:
selecting the at least one seam of pixels based on the metadata and an energy associated with each pixel of the seam of pixels;
wherein the metadata includes an energy associated with a pixel of the one frame, a motion vector, a type of programming associated with the one frame, or a total energy of the one frame.

5. The method of claim 1, further comprising:
weighting an area of the one frame so that the at least one seam of pixels is more likely to include pixels included in the area.

6. The method of claim 1, wherein the scaling step comprises at least one of removing a pixel from the seam or adding a pixel to the one frame based on a pixel of the seam.

7. A method of processing video data, comprising:
determining whether a frame is to be scaled based on at least one seam of pixels based on at least one of information derived from the frame or metadata relating to the frame;
wherein the at least one seam of pixels is selected based at least on an energy associated with each pixel of the at least one seam of pixels.

8. The method of claim 7, wherein the information derived from the frame comprises a total energy associated with the frame.

9. The method of claim 7, wherein determining comprises:
comparing a value derived from at least one of the information derived from the frame or the metadata to a threshold.

10. The method of claim 9, further comprising:
enabling a user to adjust the threshold.

11. The method of claim 7, wherein determining comprises:
determining whether the frame is to be scaled based information derived from a previous frame.

12. The method of claim 11, wherein the information derived from the previous frame includes post-processing information, a seam identified in the previous frame, or a motion vector between the frame and the previous frame.

13. A method of communicating video data, comprising:
transmitting a frame and metadata associated with the frame to a receiver, wherein the metadata comprises at least one of:
data used by the receiver to decide whether to scale the frame based on at least one seam of pixels; and
data used by the receiver to select the at least one seam of pixels.

14. The method of claim 13, further comprising:
selecting the at least one seam of pixels in the frame based on at least an energy associated with each pixel of the seam of pixels, wherein the metadata includes the at least one seam of pixels.

15. The method of claim 13, further comprising:
computing a total energy associated with the frame, wherein the metadata further comprises the total energy.

16. The method of claim 13, further comprising:
determining a motion vector between the transmitted frame and a previously transmitted frame of the video data, wherein metadata comprises the motion vector.

17. A system for scaling video data, comprising:
a processor; and
a memory in communication with said processor, said memory for storing a plurality of processing instructions for directing said processor to:
scale one frame based on at least one seam of pixels of the one frame;
wherein the seam of pixels is selected based at least on information derived from at least one of: a previous frame and metadata relating to the one frame.

18. The system of claim 17, further comprising the processor to:
select the at least one seam of pixels based on the information derived from the previous frame and an energy associated with each pixel of the at least one seam of pixels;
wherein the information derived from the previous frame includes post-processing information, a seam chosen in the previous frame, or a motion vector between the one frame and the previous frame.

19. The system of claim 17, wherein the metadata includes a seam of the at least one seam, further comprising the processor to:
extract the seam from the information received from the metadata.

20. The system of claim 17, further comprising the processor to:
weight an area of the one frame so that the at least one seam of pixels is more likely to include pixels included in the area.

21. The system of claim 17, further comprising the processor to:
select the at least one seam of pixels based on the metadata and an energy associated with each pixel of the seam of pixels;
wherein the metadata includes an energy associated with a pixel of the one frame, a motion vector, a type of programming associated with the first frame, or a total energy of the one frame.

22. A system for communicating video data, comprising:
a processor; and
a memory in communication with said processor, said memory for storing a plurality of processing instructions for directing said processor to:
transmitting a frame and metadata associated with the frame to a receiver, wherein the metadata comprises at least one of:
data used by the receiver to decide whether to scale the frame based on at least one seam of pixels; and
data used by the receiver to select the at least one seam of pixels.

23. The system of claim 22, further comprising the processor to:
select the at least one seam of pixels in the frame based on at least an energy associated with each pixel of the seam of pixels, wherein the metadata includes the at least one seam of pixels.

24. The system of claim 22, further comprising the processor to:
compute a total energy associated with the frame;
wherein the metadata further comprises the total energy.

25. The system of claim 22, further comprising the processor to:
determine a motion vector between the transmitted frame and a previously frame of the video data, wherein metadata comprises the motion vector.

26. A computer readable medium carrying one or more sequences of one or more instructions for execution by one or more processors to perform a method of scaling video data, the instructions when executed by the one or more processors, cause the one or more processors to:
scale one frame based on at least one seam of pixels of the one frame;
wherein the seam of pixels is selected based at least on information derived from at least one of: a previous frame and metadata relating to the one frame.

27. The computer readable medium of claim 26, wherein the computer readable medium includes instructions used to manufacture the one or more processors.
